(19) United States
(12) Patent Application Publication
(10) Pub. No.: US 2023/0359887 A1
(43) Pub. Date: Nov. 9, 2023

(54) AUTOMATIC LABELING SYSTEM AND OPERATING METHOD THEREOF

(71) Applicant: FENG CHIA UNIVERSITY, Taichung City (TW)

(72) Inventors: KUAN-HUNG CHEN, Taichung City (TW); DE-SHENG CHEN, Taichung City (TW)

(21) Appl. No.: 18/080,703

(22) Filed: Dec. 13, 2022

(30) Foreign Application Priority Data
May 4, 2022 (TW) 111116816

(51) Int. Cl. G06N 3/08

(52) U.S. Cl. CPC G06N 3/08

(57) ABSTRACT

The present invention provides an automatic labeling system and operating method thereof. The automatic labeling system comprises a data access end, a CPU and a GPU. The CPU may co-operate with the GPU to use the data which is saved in the data access end for training neural network models, and therefore to create automatic prediction algorithms which are used to process and label different types of data automatically. Therefore, the present invention is able to establish object detection datasets, semantic segmentation datasets and tracking datasets automatically. On the other hand, the present invention further provides a quantitative evaluation tool which is used for evaluating the trained neural network models.

### TECHNICAL FIELD

The present invention provides an automatic labeling system and operating method thereof. Specifically, the automatic labeling system only requires few labeled data for training the neural network models. Thereafter, the trained neural network models automatically label the data for creating dataset.

### BACKGROUND OF RELATED ARTS

In various practical aspects of artificial intelligence, the image recognition or real-time monitoring are the most important topics at present. Specifically, the combination of deep learning technology is one of the well-known development trends. In the training process of the neural network model, the data probably used for training need to be labeled manually and correctly.

However, in order to generate a neural network model with a high prediction accuracy rating, most neural network models need thousands of correctly labeled images or tracking data as training samples. Specifically, the correctness of these data mainly relies on manual labeling. But the labeling operator needs to use a window to extract each object range one by one and indicate the correct name. Moreover, the operator needs to repeatedly confirm the correctness of these labeling after completing the labeling operation, the whole process is quite time-consuming and labor-intensive.

In addition, different neural network models need to be trained for applications in different industries. However, when the datasets which are used for training the neural network model are all required manual labeling by experts of different disciplines, the labeling workflow, time consuming, and accuracy control will become more stringent.

Moreover, when there is a need for discrimination of completely different kind of object detection standards, the labeling operation is more difficult to manually update the all labeled dataset; the reason is that the amount of data covered by the data sets that have been used for a long time is usually very huge.

### SUMMARY

In order to solve the problems mentioned in the prior art, the present invention provides an automatic labeling system and the operating method per se.

The automatic labeling system mainly comprises a data access end, a central processing unit, and a graphics processing unit. The data access end saves a plurality of labeled object detecting data, a plurality of labeled sematic segmentation data, a plurality of labeled tracking data, a plurality of unlabeled object detecting data, a plurality of unlabeled sematic segmentation data, and a plurality of unlabeled tracking data. The central processing unit is connected with the data access end, and the graphics processing unit is connected to the central processing unit.

The central processing unit cooperates with the graphics processing unit to perform the following steps: (A) providing abovementioned automatic labeling system, then it perform step (B), the central processing unit cooperates with the graphics processing unit to access at least one part of the plurality of labeled object detecting data, at least one part of the plurality of labeled sematic segmentation data, and at least one part of the plurality of labeled tracking data from the data access end.

Proceeding to performing step (C), the central processing unit cooperates with the graphics processing unit to sequentially feed at least one part of the plurality of labeled object detecting data, at least one part of the plurality of labeled semantic segmentation data, and at least one part of the plurality of labeled tracking data to a first neural network model, a second neural network model, and a third neural network model for model training.

In the step (D), the central processing unit validates the whether the trained first neural network model, the second neural network model, and the third neural network model satisfy a preset accuracy requirement according to the preset accuracy requirement; if the validation is satisfied, then it perform step (E); if the validation is not satisfied, then it directly perform step (F).

Accordingly, when the preset accuracy requirement is satisfied, it is generated respectively a predictive object detecting data labeling algorithm, a predictive semantic segmentation data labeling algorithm, and a predictive tracking data labeling algorithm in step (E), then it perform step (G).

Conversely, if the preset accuracy requirement cannot be satisfied. In step (F), the central processing unit cooperates with the graphics processing unit to additionally accesses another part of the plurality of labeled object detecting data, another part of the plurality of labeled sematic segmentation data, and another part of the plurality of labeled tracking data from the data access end to retrain the first neural network model, the second neural network model, and the third neural network model in sequence, and additionally accesses until the first neural network model, the second neural network model, and the third neural network model meet the preset accuracy requirement, then it perform step (E).

Finally, in step (G), the central processing unit cooperates with the graphics processing unit to automatically classify and automatically label the plurality of unlabeled object detecting data in sequence through the predictive object detecting data labeling algorithm, the predictive semantic segmentation data labeling algorithm, and the predictive tracking data labeling algorithm, and generates an object detecting dataset, a semantic segmentation dataset, and a tracking dataset in sequence.

The above-mentioned descriptions are only preferred embodiments of the present invention and are not intended to limit the scope of implementation of the present invention. Therefore, all the shapes, structures, features, and spirits described in the scope of the patent application of the present invention shall be regarded as equivalent to the changes and modifications per se, and be included in the scope of the patent application of the present invention.

### BRIEF DESCRIPTION OF THE DRAWINGS

FIG. 1 is a system structure diagram of the automatic labeling system of the present invention.

FIG. 2 is a flow chart of the operating method of the automatic labeling system of the present invention.

### DETAILED DESCRIPTION OF THE INVENTION

To make the description of the present disclosure more detailed and complete, the following description provides an illustrative description for the implementation and specific embodiments of the present invention. However, the following description is not the only form of implementing or using specific embodiments of the invention. In these paragraphs, the features of various specific embodiments are covered as well as the method steps and sequences for constructing and operating these specific embodiments. However, the other embodiments may also be utilized to achieve the same or equivalent function and sequence of steps.

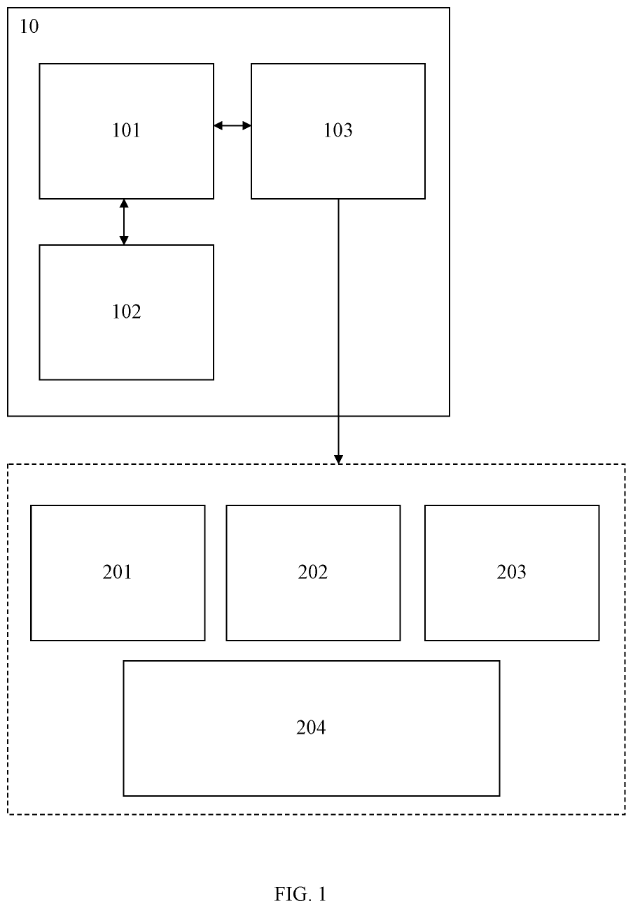

First, as shown in FIG. 1, FIG. 1 is a system structure diagram of the automatic labeling system of the present invention.

As shown in FIG. 1, the automatic labeling system 10 of the embodiment mainly included central processing unit 101, graphics processing unit 102, and data access end 103. The data access end 103 saved a plurality of labeled object detecting data, a plurality of labeled sematic segmentation data, a plurality of labeled tracking data, a plurality of unlabeled object detecting data, a plurality of unlabeled sematic segmentation data, a plurality of unlabeled tracking data. The central processing unit 101 is connected to the data access end 103, the graphics processing unit 102 is connected to the central processing unit 101.

Specifically, in FIG. 1, a plurality of labeled object detecting data, a plurality of labeled sematic segmentation data, a plurality of labeled tracking data stored in the data access end 103, that are stored in the object detecting dataset 201, a semantic segmentation dataset 202, and a tracking dataset 203. The plurality of labeled object detecting data, a plurality of labeled sematic segmentation data, a plurality of labeled tracking data that in the object detecting dataset 201, a semantic segmentation dataset 202, and a tracking dataset 203 can allow the central processing unit 101 cooperates with the graphics processing unit 102 to be used as samples for training the neural network model.

In the embodiment, the central processing unit 101 is Intel® Core™ i7-6700 processor, and the graphics processing unit 102 is NVIDIA™ GeForce GTX 1080™. As for the data access terminal 103, it can be any series/parallel combination of single or multiple elements with data storage function. The data access end 103 comprise Random Access Memory (RAM), Read-Only Memory (ROM), Flash memory or a combination thereof.

The term that the central processing unit 101 and the graphics processing unit 102 “cooperatively” train the neural network model in this embodiment means that the central processing unit 101 and the graphics processing unit 102 can be trained by the central processing unit according to the type of processing that their respective hardware is good at. The central processing unit 101 assigns or assists the central processing unit 101 to perform training tasks. For example, most neural network model training operations related to image or image detection and recognition can be mainly processed by the graphics processing unit 102, which is not limited in the present invention.

Similarly, since different neural network models need to be trained for automatic labeling of different types of data sets. Specifically, the neural network models that can be trained in this embodiment include, but are not limited to, a perceptron, a feedforward neural network (Feedforward, FF), a deep feedforward neural network (Deep feedforward, DFF), a radial Basic Neural Network (Radial Basis Function, RBF), Recurrent Neural Network (RNN), Long Short-Term Memory (LSTM), GRU (Gate Recurrent Unit), Auto Encoder, You Only Look Once (YOLO), Convolutional Neural Network (CNN), Deep Convolutional Inverse Graphics Network, Generative Adversarial Network (GAN), Deep Residual Network (DRN), Self-Organizing Map (SOM), Support Vector Machine (SVM), Neural Turing Machine (NTM) or combinations thereof.

In the embodiment, the trained neural network model can be evaluated by the quantitative evaluation tool 204 in a quantitative method. The central processing unit 101 can access and perform the quantitative evaluation tool 204 in the data access end 103 and can evaluate the quality of the trained neural network model. Specifically, the evaluation criterion of quantitative evaluation tool 204 is included but not limited by Mean Average Precision (mAP), Mean Intersection over Union (MIoU), and Multiple Object Tracking Accuracy (MOTA).

Further, in the embodiment, the number of at least one part of the plurality of labeled object detecting data is between 50 and 100. The number of at least one part of the plurality of labeled semantic segmentation data is between 50 and 100. The number of at least one part of the plurality of labeled tracking data is between 50 and 100.

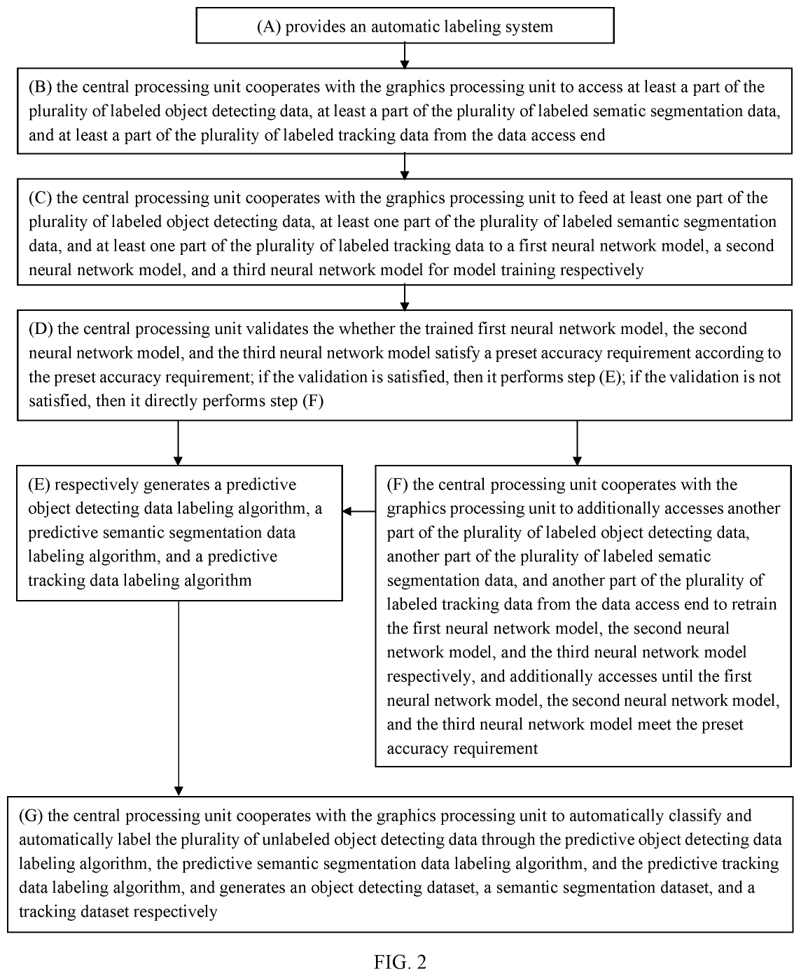

As shown in FIG. 2, which is a flow chart of the operating method of the automatic labeling system of the present invention. The central processing unit 101 in this embodiment cooperates with the graphics processing unit 102 to perform the following steps.

First, step (A) provides the automatic labeling system 10 of the present embodiment. Then step (B) is performed, the central processing unit 101 cooperates with the graphics processing unit 102 to access at least one part of the plurality of labeled object detecting data, at least one part of the plurality of labeled sematic segmentation data, and at least one part of the plurality of labeled tracking data from the data access end 103.

Specifically, step (B) is used to take a small amount of labeled data samples for training the neural network model. As mentioned above, the “small amount of labeled data samples” in step (B) refers to at least one part of the plurality of labeled object detecting data, at least one part of the plurality of labeled sematic segmentation data, and at least one part of the plurality of labeled tracking data. The number of each data is between 50 and 100.

Then step (C) is performed, the central processing unit 101 cooperates with the graphics processing unit 102 to feed at least one part of the plurality of labeled object detecting data, at least one part of the plurality of labeled semantic segmentation data, and at least one part of the plurality of labeled tracking data to a first neural network model, a second neural network model, and a third neural network model for model training respectively.

Specifically, the first neural network in the embodiment is designed based on the convolution computing method. Specifically, the algorithm of the first neural network model included two portions and a detection structure. The first portion transmits initial feature maps with different sizes to the second portion. The second portion concatenate these initial feature maps to be a feature map with an area equal to the product of length and width. The detecting structure classifies and locates the target object on each feature map to get the information of the property and location of the target object. In the embodiment, the scaling size of the above feature map is assumed to be three, and these three feature maps are with different lengths and widths, that are 13×13, 26×26, 52×52.

Further, the first portion is used as the portion of feature extraction for at least a target object, and the second portion is used as the portion to realize local feature concatenation between feature maps of different sizes.

In the embodiment, the first portion includes a plurality of convolution sets and a plurality of residual blocks. Each convolution set configured between any two residual blocks, and configured before the first residual block. Each convolution densely connected with residual blocks. Every convolution set includes at least max pooling and a least a pooling layer. In the plurality of convolution sets, the stride of the pooling layer which is connected to the first residual blocks is 2. In addition, in this embodiment, the first residual block represents the deepest residual block in the first portion.

It should be noted that the definition and implementation of the second part, the above-mentioned detection structure and the above-mentioned residual block are the same as those in the prior art, the following description will not be repeated.

The second neural network model of the embodiment is based on the algorithm structure of the encoder-decoder algorithm, which may include but not limited to residual network, convolutional neural network (CNN), upsampling, downsampling, dilated/atrous convolution, and other algorithms as a model for training image segmentation.

The third neural network model of this embodiment predicts the object trajectory by executing at least one target tracking algorithm. In the embodiment, the target tracking algorithm may be one of Kalman Filter, particle filter or mean-shift, and updated using IOU matching or cascade matching. Furthermore, a convolutional neural network can be used to perform a similarity calculation on the tracking results, and the similarity calculation can be based on the calculation of distance measurement methods such as cosine distance, Euclidean distance, Manhattan distance, Chebyshev distance, Minkoff distance or Mahalanobis distance.

In step (D), the central processing unit 101 validates whether the trained first neural network model, the second neural network model and the third neural network model satisfy the preset accuracy according to a preset accuracy requirement. Accuracy requirements, if the validation is satisfied, then it perform step (E); if the validation is not satisfied, then it directly perform step (F).

In the embodiment, the preset accuracy requirement verification is performed by the central processing unit which cooperates 101 with the graphics processing unit 102 to access and run the quantitative evaluation tool 204 in the data access terminal 103. The preset accuracy rating includes a first evaluation criterion, a second evaluation criterion, and a third evaluation criterion. The first evaluation criterion is used to evaluate the first neural network model, the second evaluation criterion is used to evaluate the second neural network model, and the third evaluation criterion is used to evaluate the third neural network model.

Specifically, the first evaluation criterion is used to Mean Average Precision (mAP), the second evaluation criterion is used to Mean Intersection over Union (MIoU), the third evaluation criterion is used to Multiple Object Tracking Accuracy (MOTA). The first evaluation criterion is used to evaluate the first, the second evaluation criterion, and the third evaluation criterion can be used to quantify the value of the first neural network model, the second neural network model, and the third neural network model, and to quantify whether it satisfies the preset accuracy requirement.

Specifically, as the average precision mean value of the first evaluation criterion in this embodiment, its value is set between 0 and 1. For object detection purposes, calculate the “intersection of the object area predicted by the system and the real object area” divided by the “union of the object area predicted by the system and the real object area” for all objects. For the area formed by precision and recall between the areas where ground truth bounding box and predict bounding box overlap, the average is finally taken to determine whether the first evaluation standard satisfies the standard.

Further, as the mean intersection over union (MIoU) of the second evaluation criterion in this embodiment, its value is set between 0 and 1. For image segmentation (i.e., semantic segmentation) purposes, it calculates the ratio of the overlap between ground truth pixel and predict pixel for all pixel, as the basis for determining whether the second evaluation standard satisfies the standard.

Multiple object tracking accuracy (MOTA) is used as of the third evaluation criterion in the embodiment, its value is set between −∞ and 1. The ratio of the third evaluation standard to the FN, FP, and ID switches between ground truth bounding box and predict bounding box is used as the basis for determining whether the third evaluation standard satisfies the standard.

Accordingly, when the training of the first neural network model, the second neural network model, and the third neural network model is completed and the quantitative evaluation satisfies the preset accuracy requirement, step (E) generates a predictive object detecting data labeling algorithm, a predictive semantic segmentation data labeling algorithm, and a predictive tracking data labeling algorithm in sequence, and perform step (G).

Conversely, if the preset accuracy requirement cannot be satisfied. In step (F), the central processing unit 101 cooperates with the graphics processing unit 102 to additionally access another part of the plurality of labeled object detecting data, another part of the plurality of labeled sematic segmentation data, or another part of the plurality of labeled tracking data from the data access end 103 to retrain the first neural network model, the second neural network model, or the third neural network model in sequence, and additionally accesses until the first neural network model, the second neural network model, or the third neural network model meet the preset accuracy requirement, then it perform step (E).

Finally, in step (G), the central processing unit 101 cooperates with the graphics processing unit 102 to automatically classify and automatically label the plurality of unlabeled object detecting data in sequence through the predictive object detecting data labeling algorithm, the predictive semantic segmentation data labeling algorithm, and the predictive tracking data labeling algorithm, and generates an object detecting dataset 201, a semantic segmentation dataset 202, and a tracking dataset 203 respectively as illustrated in FIG. 1.

The above-mentioned descriptions are only preferred embodiments of the present invention and are not intended to limit the scope of implementation of the present invention. Therefore, all the shapes, structures, features, and spirits described in the scope of the patent application of the present invention shall be regarded as equivalent to the changes and modifications per se, and be included in the scope of the patent application of the present invention.

What is claimed is:

1. An automatic labeling system, comprising:
a data access end, saving a plurality of labeled object detecting data, a plurality of labeled sematic segmentation data, a plurality of labeled tracking data, a plurality of unlabeled object detecting data, a plurality of unlabeled sematic segmentation data and a plurality of unlabeled tracking data;
a central processing unit, connected with the data access end; and
a graphics processing unit, connected with the central processing unit;
wherein the central processing unit cooperates with the graphics processing unit to perform the following steps:
the central processing unit cooperates with the graphics processing unit to access at least one part of the plurality of labeled object detecting data, at least one part of the plurality of labeled sematic segmentation data, and at least one part of the plurality of labeled tracking data from the data access end;
the central processing unit cooperates with the graphics processing unit to feed at least one part of the plurality of labeled object detecting data, at least one part of the plurality of labeled semantic segmentation data, and at least one part of the plurality of labeled tracking data to a first neural network model, a second neural network model, and a third neural network model for model training respectively;
the central processing unit validate the whether the trained first neural network model, the second neural network model, and the third neural network model meet a preset accuracy requirement according to the preset accuracy requirement;
if the first neural network model, the second neural network model, and the third neural network model satisfy the preset accuracy requirement, a predictive object detecting data labeling algorithm, a predictive semantic segmentation data labeling algorithm, and a predictive tracking data labeling algorithm are generated respectively;
if the first neural network model, the second neural network model, and the third neural network model do not satisfy the preset accuracy requirement, the central processing unit cooperates with the graphics processing unit to additionally accesses another part of the plurality of labeled object detecting data, another part of the plurality of labeled sematic segmentation data, and another part of the plurality of labeled tracking data from the data access end to retrain the first neural network model, the second neural network model, and the third neural network model respectively, and additionally accesses until the first neural network model, the second neural network model, and the third neural network model meet the preset accuracy requirement;
the central processing unit cooperates with the graphics processing unit to automatically classify and automatically label the plurality of unlabeled object detecting data through the predictive object detecting data labeling algorithm, the predictive semantic segmentation data labeling algorithm, and the predictive tracking data labeling algorithm respectively, and generates an object detecting dataset, a semantic segmentation dataset, and a tracking dataset respectively.

2. The automatic labeling system as claimed in claim 1, wherein the preset accuracy rating is performed by the central processing unit which cooperates with the graphics processing unit using a quantitative evaluation tool, the preset accuracy rating comprise a first evaluation criterion, a second evaluation criterion, and a third evaluation criterion; the first evaluation criterion is used to evaluate the first neural network model, the second evaluation criterion is used to evaluate the second neural network model, and the third evaluation criterion is used to evaluate the third neural network model.

3. The automatic labeling system as claimed in claim 1, wherein the central processing unit is Intel® Core™ i7-6700 processor.

4. The automatic labeling system as claimed in claim 1, wherein the graphics processing unit is NVIDIA™ GeForce GTX 1080™.

5. The automatic labeling system as claimed in claim 1, wherein the data access end comprises Random Access Memory (RAM), Read-Only Memory (ROM), Flash memory or combinations thereof.

6. The automatic labeling system as claimed in claim 2, wherein the first evaluation criterion is used to Mean Average Precision (mAP).

7. The automatic labeling system as claimed in claim 2, wherein the second evaluation criterion is used to Mean Intersection over Union (MIoU).

8. The automatic labeling system as claimed in claim 2, wherein the third evaluation criterion is used to Multiple Object Tracking Accuracy (MOTA).

9. The automatic labeling system as claimed in claim 1, wherein number of at least one part of the plurality of labeled object detecting data is between 50 and 100; number of at least one part of the plurality of labeled semantic segmentation data is between 50 and 100; and number of at least one part of the plurality of labeled tracking data is between 50 and 100.

10. An operating method of an automatic labeling system, comprise:
(A) providing the automatic labeling system as claimed in claim 1;
(B) the central processing unit cooperating with the graphics processing unit to access at least one part of the plurality of labeled object detecting data, at least one part of the plurality of labeled sematic segmentation data, and at least one part of the plurality of labeled tracking data from the data access end;
(C) the central processing unit cooperating with the graphics processing unit to feed at least one part of the plurality of labeled object detecting data, at least one part of the plurality of labeled semantic segmentation data, and at least one part of the plurality of labeled tracking data to a first neural network model, a second neural network model, and a third neural network model for model training respectively;
(D) the central processing unit validating the whether the trained first neural network model, the second neural network model, and the third neural network model meet a preset accuracy requirement according to the preset accuracy requirement; if the validation is satisfied, performing step (E); if the validation is not satisfied, performing step (F);
(E) a predictive object detecting data labeling algorithm, a predictive semantic segmentation data labeling algorithm, and a predictive tracking data labeling algorithm are generated respectively;
(F) the central processing unit cooperates with the graphics processing unit to additionally accesses another part of the plurality of labeled object detecting data, another part of the plurality of labeled sematic segmentation data, or another part of the plurality of labeled tracking data from the data access end to retrain the first neural network model, the second neural network model, or the third neural network model respectively, and additionally accesses until the first neural network model, the second neural network model, or the third neural network model meet the preset accuracy requirement, then performs step (E); and
(G) the central processing unit cooperating with the graphics processing unit to automatically classify and automatically label the plurality of unlabeled object detecting data in sequence through the predictive object detecting data labeling algorithm, the predictive semantic segmentation data labeling algorithm, and the predictive tracking data labeling algorithm, and generates an object detecting dataset, a semantic segmentation dataset, and a tracking dataset respectively.

11. The operating method of an automatic labeling system as claimed in claim 10, wherein the preset accuracy rating is performed by the central processing unit cooperates with the graphics processing unit using a quantitative evaluation tool, the preset accuracy rating comprise a first evaluation criterion, a second evaluation criterion, and a third evaluation criterion; the first evaluation criterion is used to evaluate the first neural network model, the second evaluation criterion is used to evaluate the second neural network model, and the third evaluation criterion is used to evaluate the third neural network model.

12. The operating method of an automatic labeling system as claimed in claim 11, wherein the first evaluation criterion is used to Mean Average Precision (mAP).

13. The operating method of an automatic labeling system as claimed in claim 11, wherein the second evaluation criterion is used to Mean Intersection over Union (MIoU).

14. The operating method of an automatic labeling system as claimed in claim 11, wherein the third evaluation criterion is used to Multiple Object Tracking Accuracy (MOTA).

15. The operating method of an automatic labeling system as claimed in claim 10, wherein the number of at least one part of the plurality of labeled object detecting data is between 50 and 100; the number of at least one part of the plurality of labeled semantic segmentation data is between 50 and 100; the number of at least one part of the plurality of labeled tracking data is between 50 and 100.
